(19) United States
(12) Patent Application Publication
(10) Pub. No.: US 2010/0220576 A1
(43) Pub. Date: Sep. 2, 2010

(54) OPTICAL PICKUP DEVICE AND INFORMATION RECORDING/REPRODUCTION DEVICE

(75) Inventors: Ikuya Kikuchi, Saitama (JP); Masakazu Ogasawara, Saitama (JP); Takuma Yanagisawa, Saitama (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation, Meguro-ku, Tokyo (JP)

(21) Appl. No.: 11/993,121

(22) PCT Filed: Jun. 13, 2006
(86) PCT No.: PCT/JP2006/311858

§ 371 Date: Dec. 19, 2007

(30) Foreign Application Priority Data
Jun. 23, 2005 (JP) 2005-184135

(51) Int. Cl. G11B 7/135

(52) U.S. Cl. 369/112.03; G9B/7.112

(57) ABSTRACT

The present invention makes possible a compact optical pickup device that eliminates effects due to the position where a sub beam is projected during tracking compensation, and provides for stable tracking compensation.

A diffraction grating 12 in the optical pickup device PU gives an astigmatism to a sub beam (either of ±1-dimensional light), and shines that sub beam onto an optical disc DK. Also, a tracking error signal Ste is obtained by subtracting a push-pull signal PPsub that corresponds to a sub beam from a push-pull signal PPmain that corresponds to a main beam (0-dimensional light), and tracking compensation is performed based on that tracking error signal Ste.

### TECHNICAL FIELD

This invention relates to an optical pickup device and information recording/reproduction device that are used in recording information onto or reproducing information from an optical recording medium such as an optical disc.

### BACKGROUND ART

Conventionally, in the field of information recording/reproduction devices for optical discs such as DVD (Digital Versatile Disc) or BD (Blu-ray Disc), various methods for performing tracking compensation have been proposed, and currently, the so-called DPP (differential push pull) method for performing tracking compensation by converting the light that is emitted from a light source to three beams; a main beam (0-dimensional beam) and two sub beams (±1-dimensional beams) has become typical. This DPP method is a method that compensates for push-pull offset (hereafter, referred to as ‘PP offset’) by shining the main beam and both sub beams onto a position on the disc where the push-pull signal that corresponds to the main beam and push-pull signals that correspond to the sub beams have opposite phase (that is, a groove track that is formed in the optical disc and the land tracks that are adjacent to it) and uses the value of the difference between both push-pull signals. The meaning of (i) ‘push-pull signal’ is an error signal that uses the value of the difference between received optical signals of each division when the optical receiving section of the OEIC (Optical Electronic IC) is divided into two divisions; and the meaning of (ii) ‘PP Offset’ is an offset that occurs in a push-pull signal due to a shift in the focused light spot on the OEIC.

In this way, the DPP method is capable of compensating for the PP offset, however, since it is necessary to maintain the relationship of opposite phase between the push-pull signal of the main beam and the push-pull signal of the sub beams, it is susceptible to shifts in the position where the main beam and sub beams are shone onto the surface of the optical disc. Therefore, when the position where the sub beams are shone onto the tracks changes due to variations in the track pitch of the optical disc, it becomes impossible to perform adequate tracking compensation. In order to solve this problem a method has been disclosed (see Patent Document 1) for surely and accurately acquiring a tracking error signal regardless of the position where the sub beams are shone.

Patent Document 1: Japanese Patent Laid-open No. H9-219030

### DISCLOSURE OF THE INVENTION

### Problems to be solved by the Invention

In the optical pickup device disclosed in Japanese patent application H9-219030, a method is used in which the sub beams are forcibly defocused in order to prevent track information from overlapping in the push-pull signal that corresponds to the sub beams, and a compensation signal is obtained that indicates just the amount of PP offset. Therefore, when a cylindrical lens is used for detecting focus error (so called astigmatic method), the shape of the focused light spot on the OEIC becomes a linear or nearly linear elliptical shape, and it becomes impossible to properly obtain the push-pull signal. In this case, it becomes necessary to have an OEIC for detecting tracking error that is separate from the OEIC for detecting RF and focus error, so making the optical pickup device itself compact becomes difficult.

Also, when construction is used in which the sub beams are defocused on the disc surface is this way, there is a possibility that the sub beams will become focused by defects that exist on the optical disc. Also, track information overlaps the push-pull signal of the sub beams, and the amount of offset cannot be calculated accurately.

Taking the situation explained above into consideration, it is the object of the present invention to provide an optical pickup device and information recording/reproduction device that are capable of eliminating the effects due to the position where sub beams are shone when the optical pickup device performs tracking compensation, thus making it possible to make the optical pickup device more compact and to perform more stable tracking compensation.

### Means for Solving the Problems

To solve the problems, one aspect of the invention is an optical pickup device which is provided with: a diffraction device for diffracting a light beam that is projected from a light source and projecting a main beam and a sub beam; a focusing device for focusing the main beam and the sub beam onto an optical recording medium having a recording track; and an optical receiving device for receiving light of the main beam and the sub beam that is reflected by the optical recording medium, and outputting a received optical signal corresponding to each beam; wherein the diffraction device gives an astigmatism to just the sub beam; and the focusing device focuses the sub beam onto the optical recording medium between (a) a first focal line and (b) a second focal line that orthogonally crosses the first focal line of the sub beam to which the astigmatism has been given.

One aspect of the invention is an information recording/reproduction device is provided with: the optical pickup device; a drive device for driving the optical pickup device; a control device for controlling the recording of data onto or reproduction of data from the optical recording medium by controlling the drive device; and an output device for outputting a signal that corresponds to the received optical results received by the optical pickup.

### BRIEF DESCRIPTION OF THE DRAWINGS

FIG. 1 is a drawing showing MTF characteristics of an information recording/reproduction device that uses the fundamentals of the present invention when a main beam and sub beams to which an astigmatism has been given are shone onto the surface of an optical disc at near a circle of least confusion.

FIG. 2 is a drawing showing the signal characteristics of the push-pull signals PPmain and PPsub that correspond to the main beam and sub beam that are obtained when an astigmatism is given to only the sub beam.

FIG. 3 is a drawing showing the relationship 3-dimensionally between the main beam and sub beam that are shone onto an optical disc DK.

FIG. 4 is a block diagram showing the main construction of an information recording/reproduction device RP of an embodiment of the invention.

FIG. 5 is a block diagram showing the detailed construction of the OEIC 19, received optical signal processing unit OP and actuator drive unit AD of an embodiment of the invention.

FIG. 6 is drawing showing the relationship between the tracks that are formed on the surface of an optical disc DK and the main beam and sub beam that are shone onto the surface of the disc.

FIG. 7(a) is graph showing the MTF characteristics for the case when the astigmatic angle is ‘0°’ (dashed line), and the case when the astigmatic angle is ‘45°’, and FIG. 7(b) is an enlarged graph of the specified section shown in FIG. 7(a).

FIG. 8(a) is a drawing showing the focused state on the surface of the optical disk DK when the astigmatic angle is ‘45°’, FIG. 8(b) is a drawing showing the state of the main reflected light and the sub reflected light that are incident from the optical disc DK onto an object lens 171; and FIG. 8(c) is a drawing showing the state of the focused spot of the main reflected light and sub reflected light on the OEIC 19.

FIG. 9(a) is a drawing showing the focused state on the surface of the optical disk DK when the astigmatic angle is ‘0° (or 90°)’, FIG. 9(b) is a drawing showing the state of the main reflected light and the sub reflected light that are incident from the optical disc DK onto an object lens 171; and FIG. 9(c) is a drawing showing the state of the focused spot of the main reflected light and sub reflected light on the OEIC 19.

FIG. 10 is a drawing showing the state of a focused spot of ±1-dimensional light on the OEIC 19 when an astigmatism is given to both a diffractive grating 12 and error-detection lens 18 at the same angle.

FIG. 11 is a drawing showing the 3-dimensional and planar states of the sub beam that is shone onto the optical disc of a first variation of an embodiment of the invention.

FIG. 12 is a drawing showing the relationship between the astigmatic angle ‘θ’ of the sub beam and the PP offset value PPoffset for the variation shown in FIG. 11.

FIG. 13 is a graph showing the characteristics of the signals detected in the areas am, bm, cm and dm of the main optical receiving section 191 of the variation shown in FIG. 11.

FIG. 14 is a drawing showing the waveform of the push-pull signal PPmain of the variation shown in FIG. 11 when the value of the signal is a minimum.

FIG. 15 is a block diagram showing the detailed construction of the OEIC 19, received optical signal processing unit OP and actuator drive unit AD of a second variation of an embodiment of the invention.

FIG. 16(a) is a graph showing the characteristics of the focus-error signal Sfes that is obtained from the astigmatic method when a sub beam to which an astigmatism is given is shone onto the optical disc in the variation shown in FIG. 15; and FIG. 16(b) is a graph showing the characteristics of the focus-error signal when a defocused sub beam is shone onto the optical disc DK.

FIG. 17 is a block diagram showing the detailed construction of the OEIC 19, received optical signal processing unit OP and actuator drive unit AD of a third variation of an embodiment of the invention.

FIG. 18 is a graph comparing the characteristics of the focus-error signal Sfes that is obtained from the astigmatic method of a fourth variation of an embodiment of the invention.

FIG. 19 is a concept diagram of a fifth variation of an embodiment of the invention showing the problems when there is a plurality of object lenses and one object lens is placed in a position that is shifted in the tangential direction of the optical disc DK.

### EXPLANATION OF LETTERS OR NUMERALS

RP . . . information recording/reproduction device
OP . . . received optical signal processing unit
AD . . . actuator drive unit
SC . . . spindle control circuit
SM . . . spindle motor
IP . . . input signal processing unit
C . . . control unit
D . . . drive circuit
PU . . . optical pickup device

### BEST MODE FOR CARRYING OUT THE INVENTION

The preferred embodiments of the invention will be explained below, however, before doing so, the basic fundamentals of the invention will be explained.

### [1] Basic Fundamentals

First, when performing tracking compensation using a push-pull signal, when the arrangement position of the object lens is shifted by the tracking servo, the focus spot of the light beam on the OEIC also shifts due to this and generates a PP offset. This PP offset becomes an obstacle when performing tracking compensation, so from the aspect of improving the accuracy of tracking compensation, eliminating the PP offset is an important factor.

The DPP method is one method for eliminating this PP offset, however, in this DPP method, construction is used in which the main beam and sub beam are narrowed down to their resolution limits and shone onto the surface of the optical disc DK, so track information (information that indicates the wobbling caused by the groove track, information that corresponds to the pits in the groove track, etc.) components in the push-pull signal become overlapped. In other words, the push-pull signals PPmain, PPsub1 and PPsub2 (here ‘1’ and ‘2’ are used for distinguishing between the +1-dimensional light and −1-dimensional light, respectively) that correspond to the main beam and sub beams that are obtained at this time become as shown below when the track information component is taken to be sin θ:

PPmain=sin θ+offset (Equation 1)

PPsub1=(1/G) (−sin θ+offset) (Equation 2)

PPsub2=(1/G) (−sin θ+offset) (Equation 3)

(‘G’ is a coefficient that corresponds to the amount of light diffraction of the main beam and sub beams), and

DPP=PPmain−(G/2) (PPsub1+PPsub2)=2 sin θ (Equation 4).

Therefore, maintaining a positive-negative inverted relationship between the values of the track information components in Equations (1) to (3) becomes the absolute condition for canceling only the PP offset component from the push-pull signal, and in order to make this DPP method possible, the positions where the sub beams are shone onto the disk must be adjusted exactly.

On the other hand, this relationship proves that it is possible to cancel just the PP offset by removing the track information components from the push-pull signals PPsub and using the difference with the push-pull signal PPmain. In this invention, a method is used as the method for removing the track information components in which when diffracting the light that is emitted from a light source into a main beam and sub beams, an astigmatism is given to only the sub beams, and the sub beams are shone onto the surface of the optical disk in this state of having an astigmatism. When astigmatism is given to the sub beams in this way, the size of the focused spot of light of the sub beams that are focused onto the optical disk becomes larger than when astigmatism is not given to the sub beams, so the degree of modulation of the push-pull signal PPsub greatly decreases.

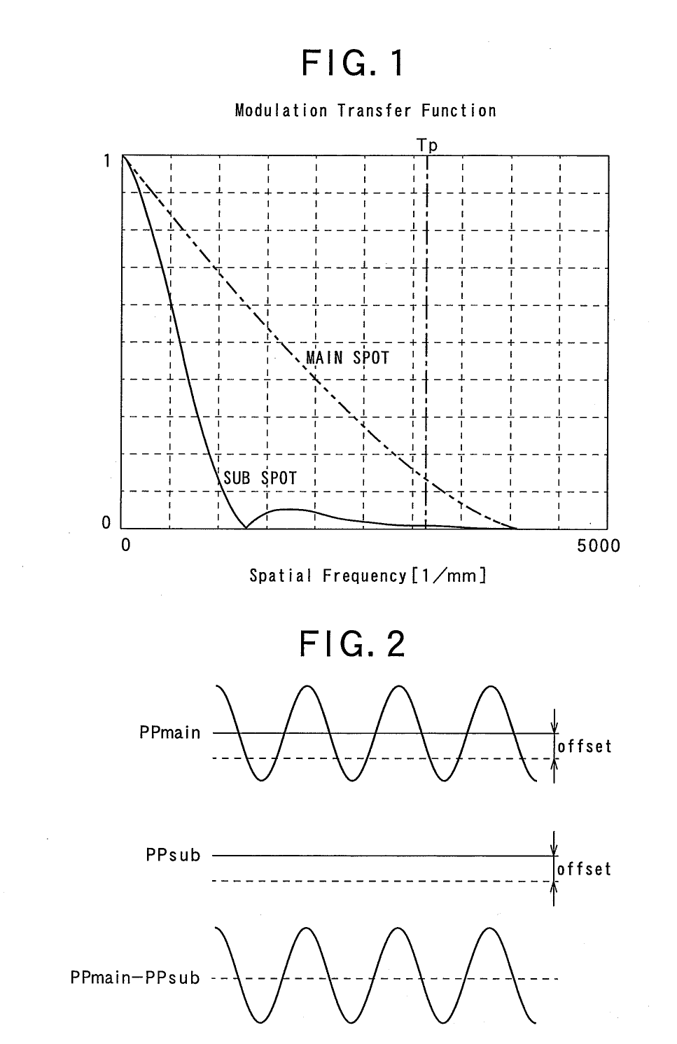

This point will be explained using FIG. 1 as a reference. FIG. 1 is a drawing showing the MTF (Modulation transfer Function) characteristics when the main beam and sub beam, to which an astigmatism (350 mλ) has been given, (both having a wavelength of 405 nm) are shone onto the surface of the optical disc at near a circle of least confusion, and in FIG. 1, the spatial frequency (number of light and dark spots existing per 1 mm) is taken to be along the x-axis, and the MTF characteristic that corresponds to the main beam is shown by the dashed line and the MTF characteristic that corresponds to the sub beam is shown by the solid line.

Supposing that the MTF value necessary for reading track information from the optical disk is ‘0.1’, it can be seen that at the spatial frequency (Tp in FIG. 1) that corresponds to a BD track pitch of ‘0.32 μm’, the value of MTF of the main beams becomes ‘0.15’, which is a MTF characteristic for which all of the track information can be read. However, in regards to the sub beams to which an astigmatism has been given, the value of MTF becomes nearly ‘0’ (in other words, it does not have resolution that corresponds to the track pitch), so it can be seen that the sub beams cannot reproduce the track information.

FIG. 2 shows the signal characteristics of the push-pull signals PPmain and PPsub that correspond to the main beam and sub beams that are obtained when an astigmatism is given to just the sub beams. As shown in FIG. 2, when a specified amount of astigmatism is given to the sub beams, it can be seen that the track information component is deleted from the push-pull signal PPsub that corresponds to the sub beams, and the track information component in the push-pull signal is reduced to a level that is recognized as noise. As a result, the push-pull signal PPsub that corresponds to the sub beams is expressed by just the amount of PP offset, and by using the value of the difference between the push-pull signal PPmain that corresponds to the main beam and the push-pull signal PPsub that corresponds to the sub beams, it is possible to compensate for the PP offset.

FIG. 1 shows the MTF characteristics for the push-pull signals when the amount of astigmatism is taken to be 350 mλ, however, it is known that actually the MTF value especially becomes small when the amount of astigmatism is 150, 275 and 350 mλ. When an astigmatism of 220 mλ, or more is given, it is possible to take the MTF value of the sub beams to be a sufficiently small value.

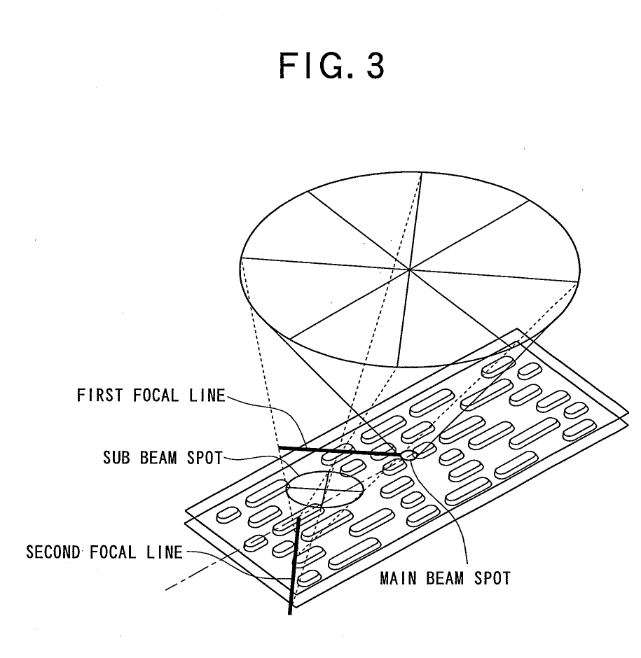

Also, when shining the sub beams to which an astigmatism has been given onto the optical disc, the track information can be similarly cancelled even when the sub beams are shone onto the optical disc in a linear state (focal line), however, in that case, the shape of the focused spot of light on the OEIC becomes a line, and it becomes difficult to obtain a push-pull signal that corresponds to the sub beams. Therefore, in this invention, as shown in FIG. 3, the optical system is designed so that the sub beams are shone onto the optical disc between a first focal line and a second focal line (in other words, a position that becomes the circle of least confusion or an elliptical shape, or ideally near the circle of least confusion).

Furthermore, two sub beams that correspond to ±1-dimensional light are projected from the diffraction grating when diffracting a light beam, however, with the optical pickup of this invention, it is possible to compensate for push-pull offset when using either just one of the sub beams, or when using both. Therefore, in the embodiment of the invention described below, only one of the sub beams is used, however, the form of using both sub beams is explained in a variation of the embodiment (hereafter, when simply referring to a ‘sub beam’, will mean a sub beam that is used for compensation of the PP offset, and when using two sub beams the sub beams will be referred to as ‘sub beam a’ and ‘sub beam b’).

### [2] Preferred Embodiment

### [2.1] Construction of the Embodiment

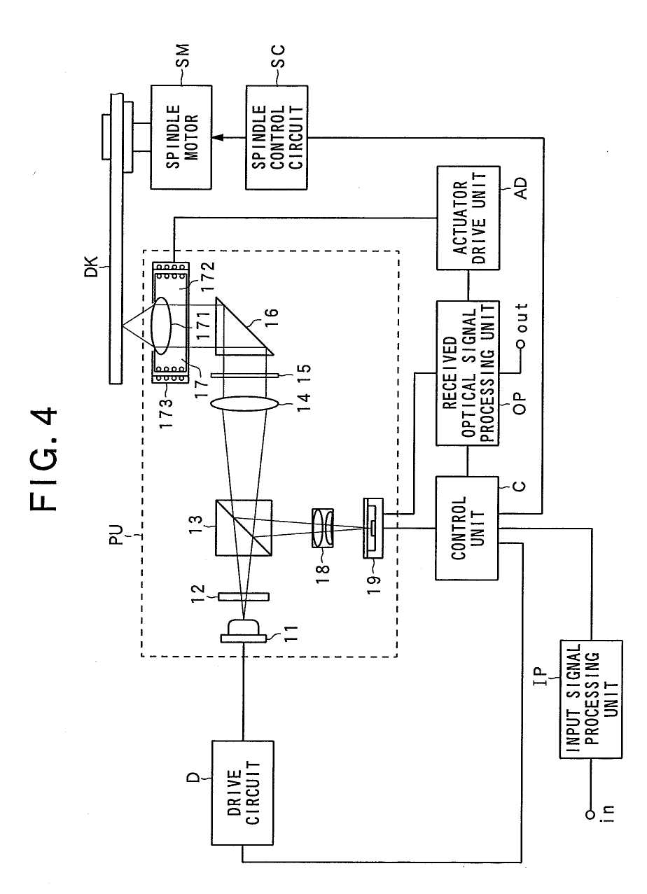

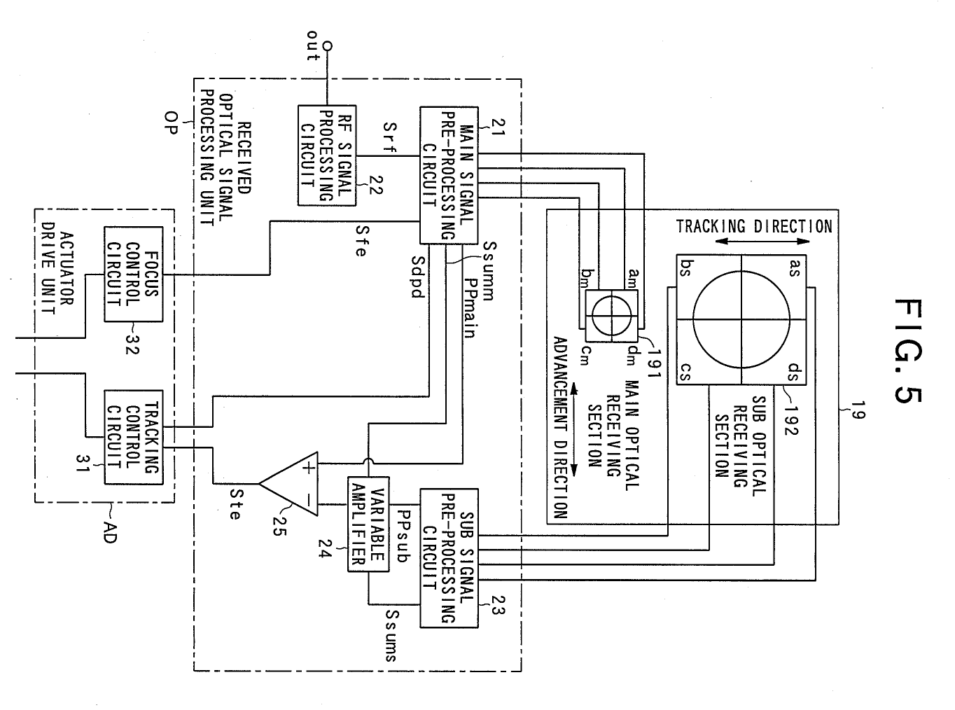

First, FIG. 4 shows the main construction of the information recording/reproduction device RP of an embodiment of the invention. This information recording/reproduction device RP uses the optical pickup device of the present invention in a BD recorder that records information onto or reproduces information from an optical disc DK that corresponds to BD format. As shown in FIG. 4, the information recording/reproduction device RP of this embodiment comprises: an input signal processing unit IP, a control unit C, a drive circuit D, an optical pickup device PU, a received optical signal processing unit OP, an actuator drive unit AD, a spindle motor SM for rotating a clamped optical disc, and a spindle control circuit SC for controlling the rotation of the spindle motor SM. It is not shown in the figure, however, the optical pickup device PU of this information recording/reproduction device RP is supported by a spindle shaft that is fixed in a carriage, and by moving this carriage along a slider axis (hereafter, referred to as the ‘carriage servo’), the optical pickup device PU can be moved in the direction of the radius of the optical disc DK.

Of these components, the input signal processing unit IP has an input terminal, and performs specified format signal processing of the data that is input from the outside via the input terminal, then outputs the result to the control unit.

The control unit mainly comprises a CPU (Central Processing Unit), and controls all of the parts of the information recording/reproduction device P. For example, when recording data onto the optical disc DK, the control unit C outputs a drive signal to the drive circuit D for recording the data that is input from the input signal processing unit IP, and when reproducing data that is recorded on the optical disc DK, outputs a drive signal to the drive circuit D for reproducing data. Also, when doing this, the control unit C supplies a control signal to the spindle control circuit SC and controls the rotation of the optical disc DK.

The drive circuit mainly comprises an amplifier circuit, and after amplifying the drive signal that is input from the control unit C, supplies that amplified signal to the optical pickup device PU. The amplification rate of this drive circuit D is controlled by the control unit C, and when recording data onto the optical disc DK, the amplification rate is controlled so that an optical beam is output from the optical pickup device PU at recoding power (amount of energy at which phase changes occur on the optical disc DK), and when reproducing data, the amplification rate is controlled so that an optical beam is output at reproduction power (the amount of energy at which phase changes do not occur).

The optical pickup device PU shines a light beam on the optical disc DK having BD format based on a control signal that is supplied from the drive circuit D, and is used for recording data onto or reproducing data from that optical disc DK.

In order to realize the function of this embodiment, the pickup device PU of the embodiment comprises: a semiconductor laser 11 that outputs a linearly polarized (for example P polarized) light beam (405 nm) that is polarized in a specified direction based on the drive signal that is supplied from the drive circuit D, a diffraction grating 12, a PBS (Polarization Beam Splitter) 13, a collimator lens 14, a λ/4 plate 15, a mirror 16, an actuator unit 17, an error-detection lens 18, and OEIC 19. Also, each optical element is located so that the sub beam is shone onto the optical disk near the position where the sub beam becomes the circle of least confusion. In the claims, the ‘focusing device’ corresponds to an object lens 171 of the actuator unit 17, and can arbitrarily include or not include an optical element such as the PBS 13 that is located in the optical path.

First, the diffraction grating 12 comprises a hologram element, for example, and diffracts a light beam that is projected from the semiconductor laser 11 and projects a main beam and sub beam. Also, this diffraction grating 12 acts on the diffracted light as two cylindrical lenses that are orthogonal to each other (more specifically, one convex cylindrical lens and one concave cylindrical lens whose edge lines cross each other), and through the function of this diffraction grating 12, an astigmatism is given to the sub beam (for example, 350 mλ, 175 mλ, etc.). The reason for these two cylindrical lenses that are orthogonal to each other is that when only one cylindrical lens is used, when the light from the main beam is focused on the disc, the focal line of one of the sub beams is also focused on the disc, so the two lenses prevent this from happening.

The construction described above prevents the track information component from overlapping in the push-pull signal PPsub that corresponds to the sub beam, so it becomes possible to adequately compensate for PP offset that occurs in the push-pull signal PPmain that corresponds to the main beam. Also, in this embodiment, construction is such that when the diffraction grating 12 gives an astigmatism, the angle between the focal line of the sub beam and the track on the optical disc DK becomes a specified angle (hereafter, this angle will be referred to as the ‘astigmatic angle’), and with this construction, a peculiar effect occurs, which will be described in detail later.

When actually constructing the device, it is necessary that the diffraction grating 12 have a diffraction grating pattern that expressed by a hyperbolic curve given by the equation

Φ(x,y)=(2π/λ0)(a×x+b×y+c×xy)

where

a, b and c are constants, and

Φ(x, y)=2mπ(m=0, ±1, ±2, ±3 . . . ).

The PBS 13 is an optical element that, for example, lets P polarized incident light pass through, but reflects S polarized incident light, and together with guiding the main beam and sub beam that are projected from the diffraction grating 12 to the collimator lens 14, guides the light from those beams that is reflected from the surface of the optical disc DK (hereafter, the reflected light that corresponds to the main beamwill be referred to as the ‘main reflected light’, and the reflected light that corresponds to the sub beam will be referred to as ‘sub reflected light’) to the error detection lens 18. The collimator lens 14 is an optical element that converts the parts of the incident main beam and sub beam that pass through the PBS 13 to parallel beams and causes the light that is reflected from the optical disc DK to converge, and the λ/4 plate 15 is an optical element that performs interconversion between linear polarized light and circular polarized light. With the function of the λ/4 plate 15, the direction of polarization between the forward and return path changes by just π/2, and the forward path and return path are separated by the PBS 13. The ‘forward path’ is the light path of the light beam going from the semiconductor laser 11 toward the optical disc DK, and the ‘return path’ is the light path of the reflected light going from the optical disc DK toward the OEIC 19.

The actuator unit 17 comprises: an object lens 171, an object lens holder 172 that secures the object lens 171, and a moving mechanism 173 that integrally moves the object lens holder 172; and based on a compensation signal from the actuator drive unit AD, this actuator unit 17 changes the position of the object lens, making a tracking servo and focus servo possible.

The error-detection lens 18 comprises a cylindrical lens, and using the astigmatic method gives an astigmatism of about 45° to the track of the optical disc K in order to make it possible to detect focus error. The OEIC 9 comprises a photo diode, for example, and it receives the main reflected light and sub reflected light that is shone on it from the error detection lens 18, and outputs the received optical signal to the control unit C and received optical signal processing unit OP.

Next, the received optical signal processing unit OP generates a tracking error signal and focus error signal based on the received optical signal that was supplied from the OEIC 19, and supplies that signal to the actuator unit AD. Also, this received optical signal processing unit OP generates a reproduction RF signal based on the received optical signal that is supplied from the OEIC 19, and after specified signal processing is performed on that reproduction RF signal, outputs the result to the output terminal OUT.

The actuator drive unit AD controls the actuator unit 17 based on the tracking error signal and focus error signal that are supplied from the received optical signal processing unit OP. The tracking compensation method that is used when reproducing data that is recorded on the optical disc DK is arbitrary, however, in this embodiment, the DPD method is used, and in this explanation, the tracking compensation method that was explained in the section on ‘Basic Fundamentals’, will only be used when recording data to the optical disc DK.

### (2) Detailed Construction of the Received Optical Signal Processing Unit OP, Etc.

The main construction of the information recording/reproduction device RP of this embodiment was explained above, and here, the detailed construction of the OEIC 19, received optical signal processing unit OP, and actuator drive unit AD will be explained with reference to FIG. 5. FIG. 5 is a block diagram showing the detailed construction of the OEIC 19, received optical signal processing unit OP, and actuator drive unit AD of this embodiment.

As shown in FIG. 5, in the OEIC 19 there is a main optical receiving section 191 for receiving the main reflected light and a sub optical receiving section 192 for receiving the sub reflected light, and in order to perform focus error detection using the astigmatic method, both of these optical receiving sections 191, 192 are divided into four regions a, b, c and d (the added character ‘m’ means main, and ‘s’ means sub) that correspond to the track direction and radial direction of the optical disc DK. The received optical signals that are output from the main optical receiving section 191 is supplied to a main signal pre-processing circuit 21 of the received optical signal processing unit OP, and the received optical signals that are output from the sub optical receiving section 192 is supplied to a sub signal pre-processing circuit 23.

Next, the main signal pre-processing circuit 21 comprises an adder, subtractor and phase comparator (not shown in the figure), and has the five functions described below.

### <Sum Signal Generation Function>

This function is a function for generating a sum signal of the received optical signal based on the received optical signals that correspond to each region am, bm, cm and dm. Also, the main signal pre-processing circuit 21 supplies this generated sum signal to the RF signal processing circuit 22 as a reproduction RF signal Srf. As a result, the RF signal processing circuit 22 performs D/A conversion of the reproduction RF signal, and outputs the result to the output terminal. Also, the main signal pre-processing circuit 21 outputs the sum signal to a variable amplifier 24 as a sample signal Ssumm.

### <Push-Pull Signal Generation Function>

This function is a function for generating a push-pull signal PPmain that corresponds to the main beam based on the received optical signals that correspond to each region am, bm, cm and dm. When performing this function, the main signal pre-processing circuit 21 generates a push-pull signal PPmain according to Equation 5, and outputs that generated push-pull signal PPmain to the subtractor 25.

PPmain=(am+dm)−(bm+cm) Equation 5

### <Focus Error Signal Generation Function>

This function is a function for generating a focus error signal Sfe, and by using the focus error signal Sfe that is generated using this function, focus compensation by the astigmatic method is made possible. When doing this, the main signal pre-processing circuit 21 generates a focus error signal Sfe according to Equation 6, and supplies that generated focus error signal Sfe to the focus control circuit 32 of the actuator drive unit AD.

Sfe=(am+cm)−(bm+dm) Equation 6

### <DPD Signal Generation Function>

This function is a function for generating a DPD signal Sdpd for performing tracking compensation using the DPD method when reproducing data that is recorded on an optical disc DK, and when doing this, the main signal pre-processing circuit 21 supplies the DPD signal that is generated by this function to the tracking control circuit 31. This DPD signal Sdpd is used when reproducing data from an optical disc DK on which data has already been recorded (ROM type optical disc DK that is formed with phase pits), and it is not used simultaneously with the tracking error signal Ste (used when recording data onto a writable optical disc DK) that is output from the subtractor 25.

Next, the sub signal pre-processing circuit 23 comprises an adder and subtractor, and it generates a push-pull signal PPsub that corresponds to the sub beam based on the received optical signals that correspond to each of the regions as, bs, cs and ds of the sub optical receiving section 192, and outputs that signal to the variable amplifier 24. Also, this sub signal pre-processing circuit 23 generates a sum signal of these received optical signals, and outputs the sum signal as a sample signal Ssums.

The variable amplifier 24 amplifies the push-pull signal PPsub that is supplied from the sub signal pre-processing circuit 23 at a specified gain, and supplies the result to the subtractor 25. The amplification rate of this variable amplifier 24 is set based on the ratio of the sample signal Ssumm that is supplied from the main signal pre-processing circuit 21 and the sample signal Ssums that is supplied from the sub signal pre-processing circuit 23. As a result, the push-pull signal PPsub that is output from the variable amplifier 24 is supplied to the subtractor 25 in a state of the main beam and sub beam corrected by the amount of diffraction efficiency, and by generating a difference signal of the difference between the push-pull signals PPmain and PPsub, the subtractor 25 outputs a tracking error signal Ste for which the PP offset has been compensated for.

Moreover, by having the tracking control circuit 31 and focus error control circuit 32 drive the actuator unit 17 based on the tracking error signal Ste, DPD signal Sdpd and focus error signal Sfe that are supplied from the receive optical signal processing unit OP, a tracking servo and focus servo for the object lens 171 are made possible.

### (3) Astigmatic Angle Given to the Sub Beam By the Diffraction Grating 12

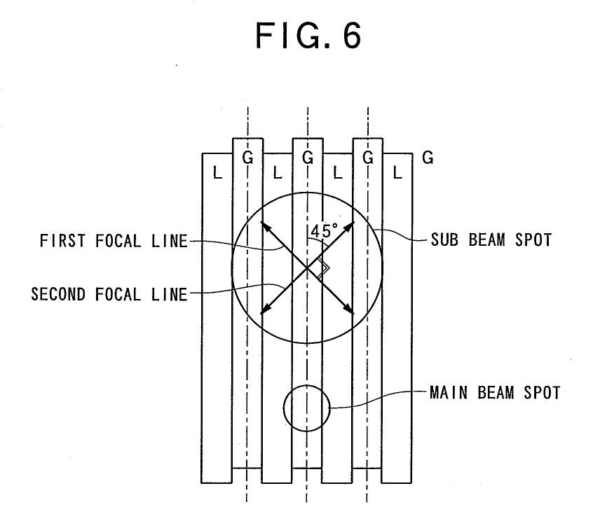

Next, the astigmatic angle that is given to the sub beam by using the diffraction grating 12 of the information recording/reproduction device RP of this embodiment is explained in detail using FIG. 6 as a reference. FIG. 6 is a drawing showing the state in which the main beam and sub beam are shone onto the surface of the optical disc DK. First, as shown in FIG. 6, in this embodiment, an astigmatism is given such that the astigmatic angle is ‘45°’. The reason for using an astigmatic angle of ‘45°’ in this way is explained below.

### (a) Improving Accuracy of the Push-Pull Signal PPsub

### (i) Improving MTF Characteristics

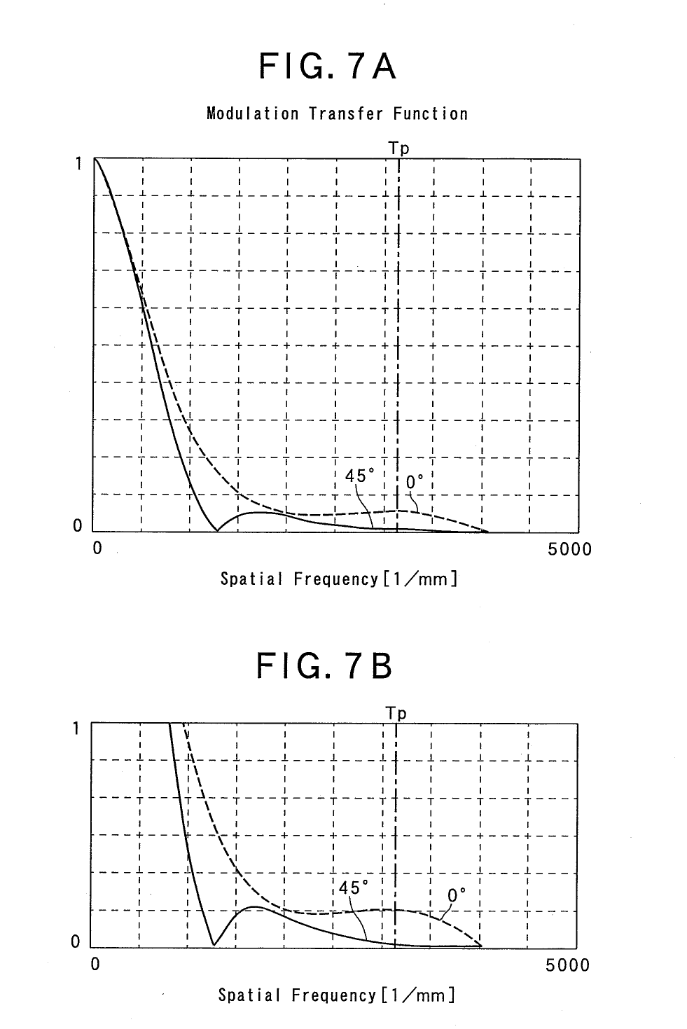

First, from tests that were performed upon completion of the present invention, it was found that the MTF characteristics were improved when the astigmatic angle given to the sub beam was ‘45°’. This point will be explained with reference to FIG. 7. In (a) of FIG. 7, a graph (the horizontal axis is the spatial frequency) of the MTF characteristics for the case of an astigmatic angle of ‘0°’ (dashed line) and the case of an astigmatic angle of ‘45°’ (solid line) are shown; and in (b) of FIG. 7, an enlarged graph is shown of a specified region in (a).

As shown in FIG. 7, the MTF values when the astigmatic angle is ‘45°’ have overall lower values than the MTF values when the astigmatic angle is ‘0°’. Particularly, at a spatial frequency that corresponds to the BD track pitch ‘0.32 μm) (Tp in FIG. 7), the MTF value when the astigmatic angle is ‘0°’ is ‘0.05’, however the MTF value when the astigmatic angle is ‘45° is ‘0.005’, and is seen to be reduced up to 1/10 (see (b) of FIG. 7).

As described above, when the MTF value that corresponds to the sub beam becomes large, the track information component included in the push-pull signal PPsub increases, and when the MTF value becomes small, the track information component decreases, so when an astigmatic angle of ‘45°’ is given, more of the track information component that is included in the push-pull signal PPsub can be removed, and the noise that occurs when compensating for PP offset can be greatly reduced. One of the reasons for using an astigmatic angle of ‘45°’ in the information recording/reproduction device RP of this embodiment was described above.

### (ii) Eliminating Effects of the Data Recording State on an Optical Disc DK

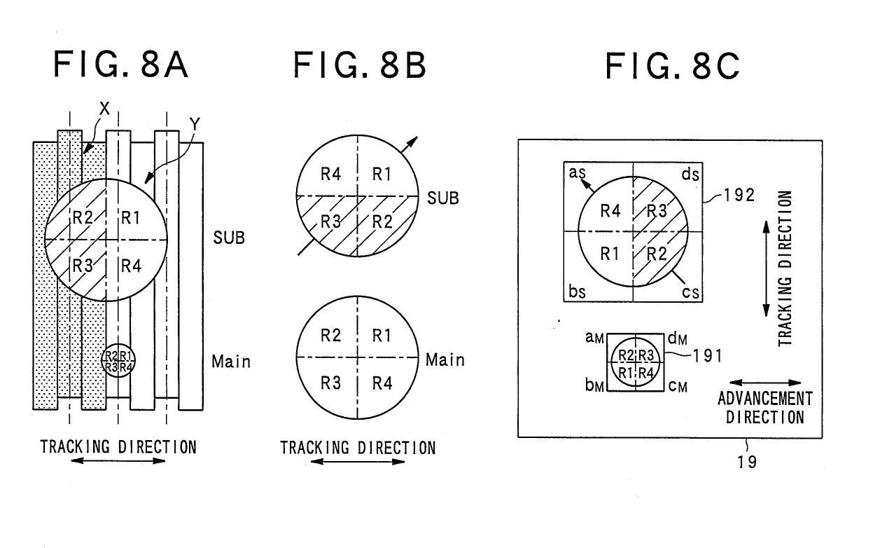

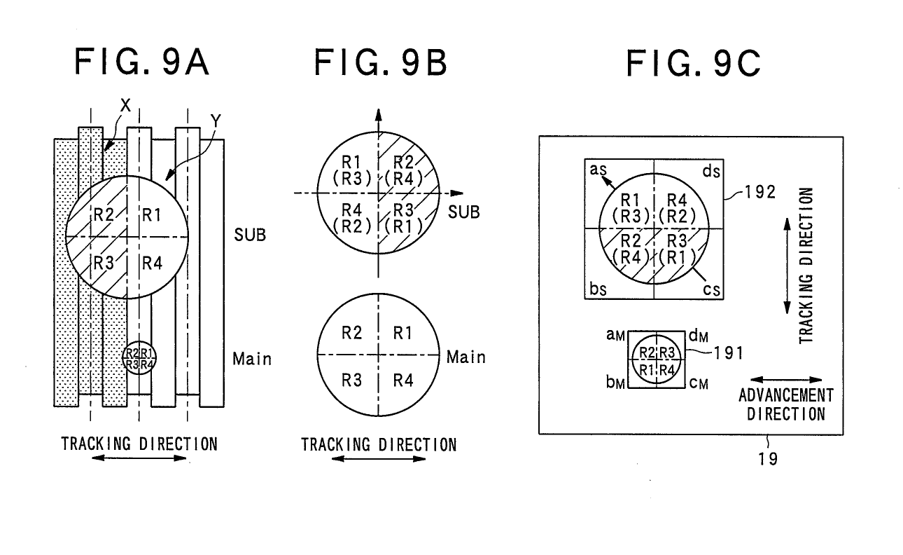

By using an astigmatic angle of ‘45°’, it also becomes possible to eliminate the effects due to difference of the data recording state on the optical disc DK. This point will be explained using FIG. 8 and FIG. 9 as a reference. In FIG. 8 and FIG. 9, (a) shows the state of light focused on the surface of the optical disc DK, (b) shows the state of the main reflected light and sub reflected light from the optical disc DK and incident on the object lens 171, and (c) shows the state of the focused spot of the main reflected light and sub reflected light on the OEIC 19. Also, FIG. 8 shows the case in which an astigmatic angle of ‘45°’ is given by the diffraction grating 12, and FIG. 9 shows the case of an astigmatic angle of ‘0°’ (values inside the parentheses is for 90°).

First, in an optical disc DK for recording use, there is a large difference between the reflectance of the area X where data is already recorded and the area Y where data is not yet recorded. This is because, in addition to the occurrence of phase changes and changes in color, the same state occurs as when phase pits are formed.

Under these conditions, when a sub beam is shone on both the recorded area X and unrecorded area Y, a phenomenon occurs in which the sub spot areas R2 and R3 become dark, and the areas R1 and R4 become light. On the other hand, when an astigmatism is given to the sub beam, the sub reflected light that is reflected by the surface of the optical disc DK is inverted around an axis that corresponds to the astigmatic angle at the center of the object lens 171, and when the light passes through the error detection lens 18, the light is inverted around a ‘45°’ axis and focused on the OEIC 19.

Therefore, when the astigmatic angle becomes ‘0°’ (or ‘90°’), a focus spot that corresponds to the areas R1 and R4 is formed on the upper side and a focus spot that corresponds to the areas R2 and R3 is formed on the lower side with respect to the dividing line in the tracking direction of the sub optical receiving section 192. As a result, light and dark regions occur above and below the dividing line in the tracking direction, and it is not possible obtain a suitable push-pull signal PPsub (as can be seen from (b) of FIG. 9 the same phenomenon occurs at ‘90°’).

On the other hand, when the astigmatic angle is ‘45°’, a spot section that corresponds to areas R3 and R4 on the upper side and to areas R1 and R2 on the lower side of the dividing line in the tracking direction appears on the sub optical receiving section 192 of the OEIC 19, and the difference in light of the received light that is shone on both the recorded area X and unrecorded area Y is cancelled out. By using an astigmatic angle of ‘45°’ in this way, it is possible to optimize the push-pull signal PPsub, so the PP offset due to the shift of the object lens 171 can be compensated for more accurately.

When actually setting the astigmatic angle, it has been shown that the same effect can be obtained within a specified range of angles from ‘45°’, and this point will be explained in the example of a variation.

### (b) Synergetic Effect With the Error Detection Lens 18

Next, a third reason for using an astigmatic angle of ‘45°’ is explained.

First, in this embodiment, construction is used in which an astigmatism having an astigmatic angle of ‘45°’ is given by the error detection lens 18 so that focus compensation by the astigmatic method using the main reflected light as described above is possible. When doing this, when the astigmatic angle that is given by the diffraction grating 12 differs from the astigmatic angle that is given by the error detection lens 18, the astigmatic angle that is given to the sub reflected light changes. This does not pose a problem when using the main reflected light in using the astigmatic method, however, as will be explained in the example of a variation, it does pose a problem when using the sub reflected light in using the astigmatic method. Of course, this problem can be solved by performing angle adjustment of the error detection lens 18 so that astigmatic angle on the OEIC 19 is ‘45°’, however, that would increase the manufacturing cost of the device.

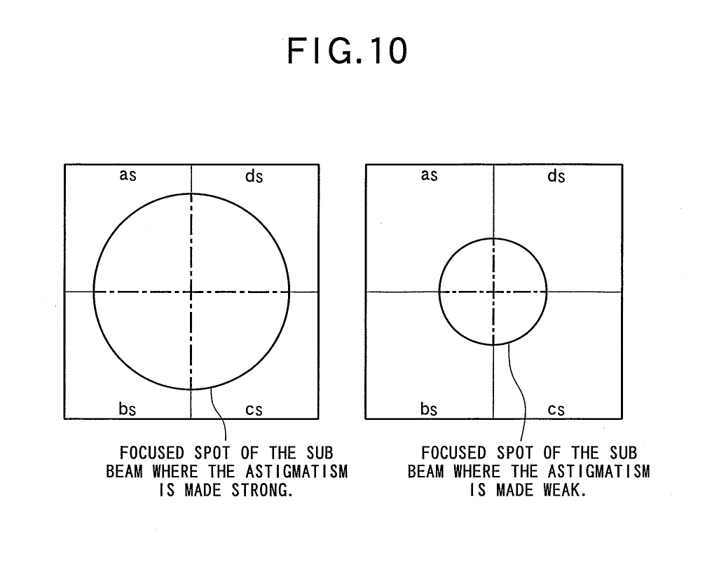

However, when the same astigmatic angle is given by both the error detection lens 18 and diffraction grating 12, a phenomenon occurs in which the astigmatism given to one of the ±1-dimensional light is strengthened and the astigmatism given to the other is weakened. In that case, as shown in FIG. 10, of the sub reflected light on the OEIC 19, the radius of the focused spot of the sub beam on the side of the strengthened astigmatism becomes large, and the radius of the sub beam on the side of the weakened astigmatism becomes small, and there is no change in the astigmatic angle. Therefore, the error detection lens 18 can be installed at ‘45°’ as in the conventional astigmatic method, so it is possible to reduce the manufacturing cost. It is arbitrary which beam is used as the sub beam, however, by increasing the amount of astigmatism of the sub beam on the OEIC 19, it is possible to further reduce the effect of track information.

### [2.2] Operation of the First Embodiment

Next, the operation of the information recording/reproduction device RP of an embodiment having the construction described above will be explained in detail, however, the operation when reproducing data that is recorded on an optical disc DK by that information recording/reproduction device RP does not differ from a conventional information recording/reproduction device (more specifically, an actuator servo is performed by a conventional DPD method and astigmatic method), so only the operation of recording data onto an optical disc DK will be explained below.

First, the user inserts an optical disc DK into the information recording/reproduction device RP, and performs an input operation to an operation unit (not shown in the figure) indicating that data will be recorded. After doing so, the control unit C executes control for performing a track search. When doing this, the control unit C supplies a control signal to the spindle control circuit SC, and together with starting the rotation of the spindle motor SM, starts supplying a drive signal to the drive circuit D so that a light beam for track searching is output from the semiconductor laser 11. Also, the control unit C executes the carriage servo, and moves the optical pickup PU to a position on the optical disc DK that corresponds with the address where data is to be recorded.

On the other hand, after the track search is complete, the control unit C supplies a control signal to the actuator drive unit AD, and changes the tracking servo loop to the closed state. When doing this, the control unit C controls the tracking control circuit 31 according to a tracking error signal Ste that is supplied from the subtractor 25 so that it performs tracking compensation, and as a result, the tracking control circuit 31 moves to a state in which it can perform the tracking compensation operation based on the tracking error signal Ste that is supplied from the subtractor 25. When the tracking servo loop is in the closed state in this way, the control unit C resets the amplification rate of the drive circuit D to a value that corresponds to the recording power, and starts supplying a drive signal that corresponds to the input signal that is supplied from the input signal processing unit IP.

However, when the drive signal is supplied from the control unit C, a signal begins to be supplied to the semiconductor laser 11 from the drive circuit D, and the semiconductor laser 11 is set to the state of emitting a light beam at recording power (wavelength 405 nm, P polarization) based on the supplied signal. When the light beam that is emitted in this way becomes incident on the diffraction grating 12, the diffraction grating 12 diffracts the light beam and projects a main beam (0-dimensional light) and sub beam (1-dimensional light). When doing this, the diffraction grating 12 gives an astigmatism to just the diffracted light, or in other words, the sub beam, and does not act as a cylindrical lens on the main beam that simply passes through the diffraction grating 12.

On the other hand, the main beam and sub beam that are projected from the diffraction grating 12 pass through a PBS 13, and after being converted to parallel light by a collimator lens 14, a λ/4 plate 15 changes the light to circular polarized light, then a mirror 16 reflects the beams in the upward direction of the figure (hereafter, simplified to ‘in the figure’), and an object lens focuses the beams onto the surface of the optical disc DK (see FIG. 6). When the main beam and sub beam are focused on the surface of the optical disc DK in this way, the main beam and sub beam are reflected by the surface of the optical disc DK, and then become incident on the object lens 171 as main reflected light and sub reflected light.

Next, the main reflected light and sub reflected light pass through the object lens 171, after which they are reflected in the left direction in the figure by a mirror, then pass through the λ/4 plate 15 which changes them to linearly polarized light (for example S polarized light) of which the polarization direction is changed by just π/2. Then after passing through a collimator lens 14, a PBS 13 reflects the beams in the downward direction in the figure, and an error detection lens 18 focuses the beams on the OEIC 19. As a result, a focused spot that corresponds to the main reflected light is formed in the main optical receiving section 191, and a focused spot that corresponds to the sub reflected light is formed in the sub optical receiving section 192, and a state is set in which a received optical signal having a level that corresponds to the amount of light received from the light reflected from the optical receiving sections 191 and 192 is output.

When a state is set in which optical signals are output from the main optical receiving section 191 and sub optical receiving section 192 of the OEIC 19, the main signal pre-processing circuit 21 generates a push-pull signal PPmain that corresponds to the main beam based on the optical signal that is supplied from the main optical receiving section 191, and starts supplying that push-pull signal PPmain to the subtractor 25. Also, at this time, the main signal pre-processing circuit 21 generates a sum signal of the optical signals in the main optical receiving section 191, and supplies that sum signal to the variable amplifier 24 as a sample signal Ssumm. This sum signal is used by the control unit C in order to adjust the gain of the drive circuit D.

Furthermore, the main signal pre-processing circuit 21 generates a focus error signal Sfe based on the received optical signal supplied from the main optical receiving section 191, and supplies that generated focus error signal to the focus control circuit 31. As a result, the focus control circuit 13 controls the actuator unit 17 based on the focus error signal Sfe, to make possible a focus servo. The method used for this focus servo is the same as in the conventional astigmatic method, so details are omitted here.

On the other hand, the sub signal pre-processing circuit 23 generates a sum signal of the received optical signals that are supplied from the sub optical receiving section 192 of the OEIC 19, and supplies that sum signal to the variable amplifier 24 as a sample signal Ssums, as well as generates a push-pull signal PPsub that corresponds to the sub beam and supplies it to the variable amplifier 24. The push-pull signal PPsub that is supplied from the sub signal pre-processing circuit 23 in this way is amplified by the variable amplifier 24 according to the ratio between the sample signals Ssumm and Ssums, and the result is supplied to the subtractor 25.

After passing through the process described above, and when the state is set in which push-pull signals PPmain and PPsub that correspond to the main beam and sub beam are supplied to the subtractor 25, a tracking error signal Ste that corresponds to the value of the difference between both push-pull signals PPmain and PPsub is output from the subtractor 25. Here, the push-pull signal PPsub that is output from the variable amplifier 24 is obtained as a DC (direct current) signal from which the track information component has been removed (or more precisely, in which very little track information component exists) (see FIG. 2), and comprises a signal level that corresponds to the PP offset that occurs in the push-pull signal PPmain that corresponds to the main beam. Therefore, the tracking error signal Ste that is output from the subtractor 25 is set to a state in which the PP offset that occurred in the push-pull signal PPmain is compensated for, and by performing a tracking servo so that the value of that tracking error signal Ste becomes ‘0’, adequate tracking compensation is possible. When doing this, the control method that is performed by the tracking control circuit 31 is the same as that performed in convention push-pull type tracking compensation, so the details of that method are omitted here.

After that, tracking compensation based on the tracking error signal Ste is executed until recording of data onto the optical disc DK is complete, and that tracking compensation is performed continuously until the recording of data onto the optical disc DK is complete.

In this way, the information recording/reproduction device RP of this embodiment uses construction that comprises: a diffraction grating 12 that diffracts a light beam that is emitted from a semiconductor laser 11 and emits a main beam and sub beam; a PBS 13 that focuses the main beam and sub beam onto an optical disc DK; a collimator lens 14; a mirror 16 and actuator unit 17; and an OEIC 19 that receives the reflected light of the main beam and sub beam from the optical disc DK and output a received optical signal that corresponds to each beam; and in which the diffraction grating 12 gives an astigmatism to just the sub beam, and that sub beam is focused on the optical disc DK between (a) a first focal line and (b) a second focal line that is orthogonal to the first focal line.

With this construction, the radius of the focused light spot of the sub beam that is shone onto the optical disc DK becomes larger than when astigmatism is given, and it becomes possible to prevent the track information component from overlapping over the push-pull signal PPsub that corresponds to the sub beam. Therefore, the push-pull signal PPsub indicates the value of the PP offset regardless of the position where the sub beam is shone, and it is possible to adequately compensate for the PP offset that occurs in the push-pull signal PPmain that corresponds to the main beam, and thus it is possible to perform stable tracking compensation with little error due to shifting of the object lens. Also, differing from the case in which the sub beam is shone onto the optical disc in a defocused state, it is possible to perform accurate focus compensation without having to use a plurality of OEIC 19, and thus it is also possible to make the optical pickup device PU more compact.

Moreover, the information recording/reproduction device RP of this embodiment uses construction in which the sub beam is shone onto the optical disc at near the circle of least confusion, so the shape of the focused spot of light of the sub reflected light that is focused on the sub optical receiving section 192 becomes circular, and it is possible to adequately obtain a push-pull signal.

Furthermore with the information recording/reproduction device RP of this embodiment, it is possible to use the astigmatic method for focus compensation, and thus it is possible to simplify the device and to reduce manufacturing costs.

In the embodiment described above, the case was explained in which data was recorded onto and reproduced from an optical disc DK that corresponds to BD format. However, the type of optical disc that is used by the information recording/reproduction device when performing recording or reproduction is arbitrary, and tracking compensation is possible with the same construction and according to the same fundamentals even in the case of recording data onto or reproducing data from an optical disc DK that corresponds to other recording formats such as a CD (Compact Disc), DVD or HD-DVD (High Definition DVD).

Also, in the embodiment described above, an example of construction was explained in which the control unit C, drive circuit D, received optical signal processing unit OP and actuator drive unit AD were constructed as a separate device (for example, a CPU) from the optical pickup device PU, however, construction is also possible in which these are integrated with the optical pickup device PU.

### [2.3] Variations

### (1) Variation 1

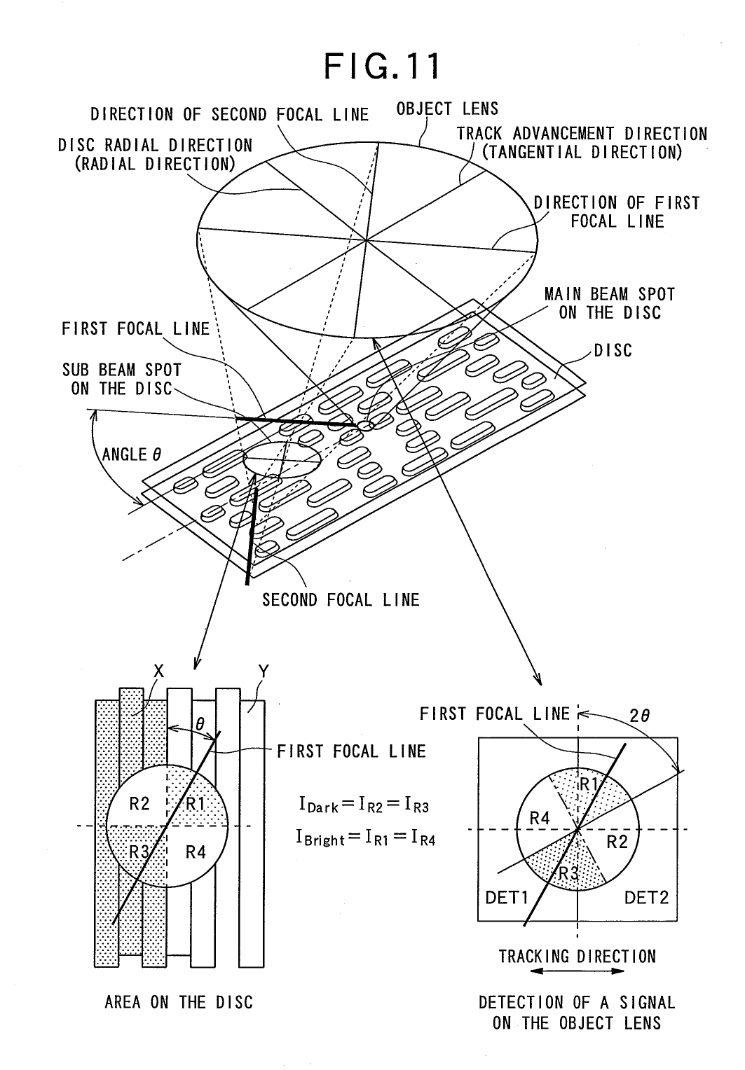

A first variation of the embodiment described above is explained with reference to FIG. 11. This variation 1 is an example of construction in which the astigmatism that is given by the diffraction grating 12 is changed from an angle of ‘45°’.

First, as shown in FIG. 11, when there is an angle 8 between the sub beam line 1 (first focal line) to which an astigmatism has been given and the track, and when the spot on the disc is divided into four, the regions are inverted by the sub beam line 1 (or in other words, the first focal line) on the object lens 171. As shown in FIG. 11, regions R2 and R3 are shone on the recorded region X, and regions R1 and R4 are shone on the unrecorded region Y, and when that is received by the sub optical receiving section 192 of the OEIC 19, tracking error is indicated as described below.

First, the intensity Idark and Ibright of the light of the recorded section and unrecorded section is given by:

Idark=Ir2=Ir3 Equation 7

Ibright=Ir1=Ir4 Equation 8

Also, the received optical signals S1 and S2 that are detected in the two regions; region DET1S (=as+ds) and region DET2S (=bs+cs) that are divided by the dividing line in the tracking direction of the sub optical receiving section 192, and the PP offset signal PPoffset are given by the following equations.

S1=(2 θ/90) Idark+{2−(2 θ/90)}Ibright Equation 9

S1=(2 θ/90) Ibright+{2−(2 θ/90)}Idark Equation 10

PPoffset=S1−S2=(180−2 θ/90) (Ibright−Idark) Equation 11

0.25×Idark≦(Ibright−Idark)≦Idark Equation 12

In these equations, S1 indicates at what ratio the bright light and dark light will enter the region DET1S on the disc due to the astigmatic angle 0 that is given to the sub beam. Also, S2 similarly indicates at what ratio the bright light and dark light will enter the region DET2S (in other words, the area of the light and dark sections of each DET).

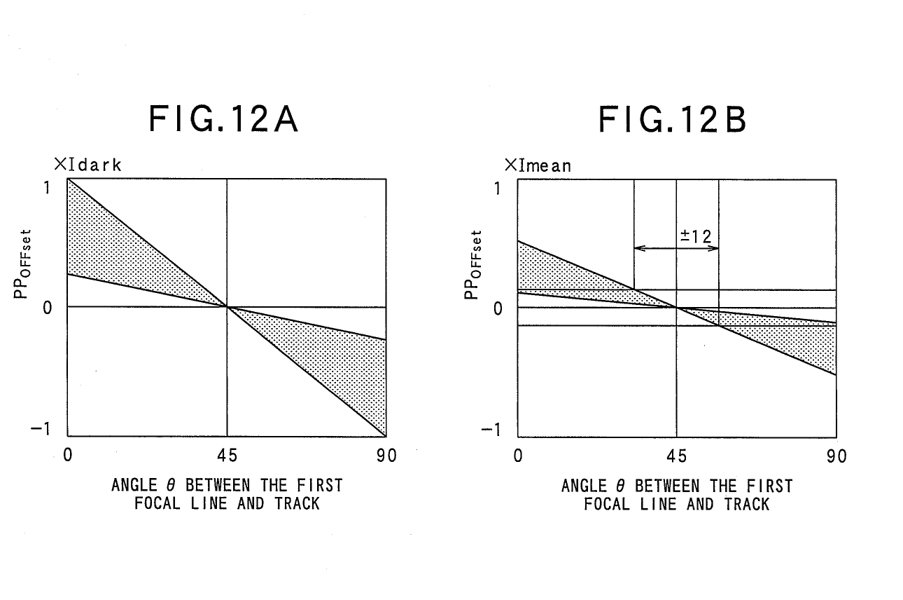

Of these equations, Equation 12 indicates the range of light and dark in the recorded and unrecorded sections that are used in the standard for a phase changing disc. FIG. 12 shows the relationship between the astigmatic angle ‘0’ of the sub beam and the PP offset value PPoffset. The shaded range is the range where the PP offset occurs. It can be seen that the PP offset value PPoffset becomes larger the greater the contrast is between the recorded region X and the unrecorded region Y, and that at an astigmatic angle ‘0’ of ‘45°’, PP offset does not occur.

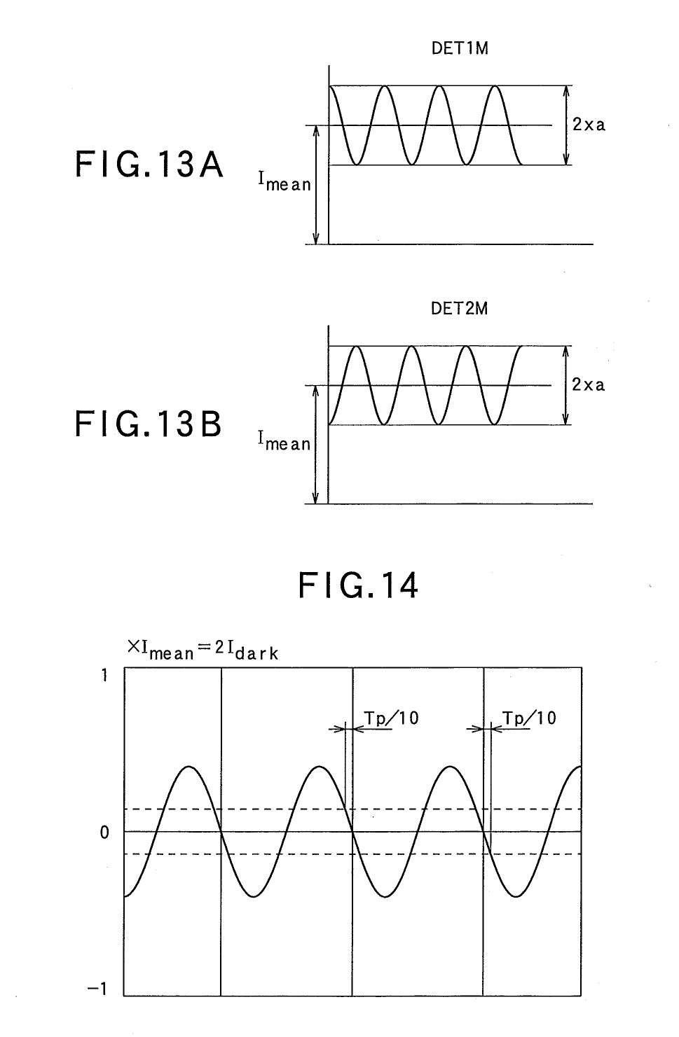

Next, the received optical signals that are detected when the main reflected light is received will be considered. FIG. 13 shows the signals that are detected in each region am, bm, cm and dm of the main optical receiving section 191. In FIG. 13, the value of the signal related to region DET1M (=am+dm) of the main optical receiving section 191 is indicated by (a), and the value of the signal related to the region DET2M (=bm+cm) is indicated by (b). Also, in FIG. 13, the horizontal axis shows the position of the spot in the radial direction of the optical disc DK, and the signals repeatedly pass over a land track and groove track, so the bias of the signals changes as a sine wave.

Now, when the main beam is received by DET1M and DET2M, there is resolution with respect to the track information, so a signal is obtained that is a sine wave that crosses the track to which the DC component of the reflected light is added (see FIG. 13). When this DC component is taken to be Imean, and the DC component of DET1M is taken to be Imean1, and the DC component of DET2M is taken to be Imean2, the difference between the two (Imean1−Imean2) corresponds to the PP offset. When considering the light and dark sections on the optical disc DK, Imean1−Imean2=0, or in other words, Imean1=Imean2=Imean. Also, the phases of the signals that are detected in the regions DET1M and DET2M of the main optical receiving section 191 are different by 180°, so the received optical signals Tedet1 and Tedet2 are given by the following equations.

TEdet1m=Imean+a×sin θ Equation 13

TEdet2m=Imean−a×sin θ Equation 14

TEsum=TEdet1m+TEdet2m=2Imean Equation 15

TEpp=2a Equation 16

Also, values and expressions differ a little depending on the disc system, however the push-pull level is regulated by the following equation.

0.26≦(TEpp/TEsum)≦0.52 Equation 17

Changing this gives

0.4Imean≦TEpp≦0.64Imean Equation 18

and the relationship

Imean=2Idark Equation 19

is established, so (A) of FIG. 12 can be expressed as (B).

FIG. 14 shows the waveform of the push-pull signal PPmain for the small signal value. The offset value that is indicated by the dotted line in the figure is the offset value in which detracking having a ‘ 1/10’ track pitch occurs. Offset of light and dark on the disc that occurs due to the recorded region X and unrecorded region Y can be allowed, and there is no problem as long as the offset is within the range ‘45°±12°’ shown in FIG. 12 (B).

As was explained above, the astigmatic angle of the astigmatism that is given to the sub beam can be within the range ‘45°±12°’, and does not strictly need to be set at ‘45°’. At the same time, this also means that the spot on the disc does not strictly need to be the circle of least confusion.

In the embodiment and variation 1 of the embodiment described above, construction was used in which in order to obtain a special effect the astigmatic angle was taken to be specified angles, however, by using any astigmatic angle the effect that was described in the section on ‘Basic Fundamentals’ is obtained, so the astigmatic angle applied does not necessarily need to be these angles.

### (2) Variation 2

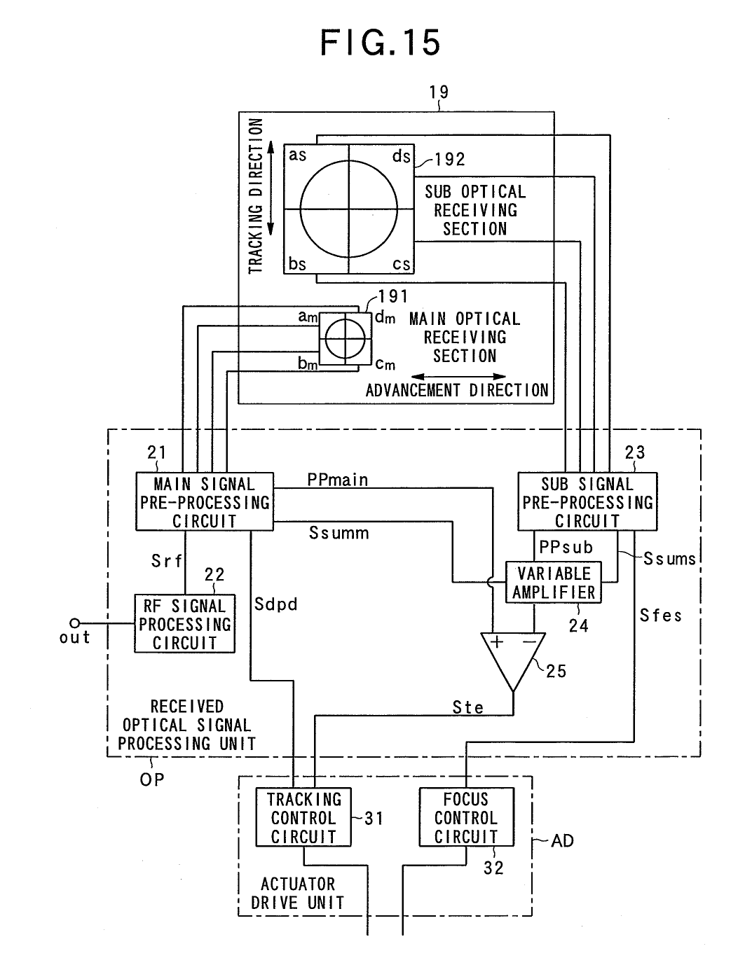

In the embodiments described above, construction was used in which focus compensation was performed based on a focus error signal Sfe that was output from a main signal pre-processing circuit 21. However, it is possible to generate a focus error signal Sfes based on received optical signals that correspond to the sub reflected light at the sub optical receiving section 192. In the case of using this kind of construction, the detailed construction of the OEIC 19, received optical processing unit OP and actuator drive unit AD is shown in FIG. 15.

As shown in FIG. 15, in the information recording/reproduction device RP of this variation, the sub signal pre-processing circuit 23 generates the focus error signal Sfes, and supplies this generated focus error signal Sfes to a focus control circuit 32. When doing this, the procedure used by the sub signal pre-processing circuit 23 to generate the focus error signal Sfe is the same as the processing that is executed by the main signal pre-processing circuit 21 in the embodiment described above (more specifically, Equation 6 is applied to the received optical signals that are received at the sub optical receiving section 192). When this method is employed, the track information component is not overlapped over the focus error signal Sfes, so it is possible to obtain a focus control signal having no track crossing noise that occurs when crossing over tracks.

On the other hand, when this method is employed, it is preferred that the astigmatic angle that is given to the sub beam by the diffraction grating 12 be kept to ‘45°’ so that there is no change in the astigmatic angle of the sub beam by the error detection lens 18. Therefore, as in the embodiment described above, an astigmatism can be given by the diffraction grating 12 so that the astigmatic angle is ‘45°’. However, in the case where the astigmatic angle that is given by the diffraction grating 12 shifts from the ‘45°’ as in the case of variation 1 described above, there will no longer be a match with the astigmatic angle that is given by the error detection lens 18, so when the light passes through the error detection lens 18, the astigmatic angle of the sub reflected light will change.

Also, as in variation 1, when there is shifting of the astigmatic angle given to the diffraction grating 12 from ‘45°’, it must be kept in mind that it is necessary to adjust the angle of the error detection lens 18 so that the astigmatic angle of the sub reflected light that is focused on the sub optical receiving section 192 becomes ‘45°’, however, by setting the amount of astigmatism that is generated by the diffraction grating 12 so that it is less than the amount of astigmatism that is generated by the error detection lens 18, it is possible to reduce the effect of shifting to the extent that it can be ignored.

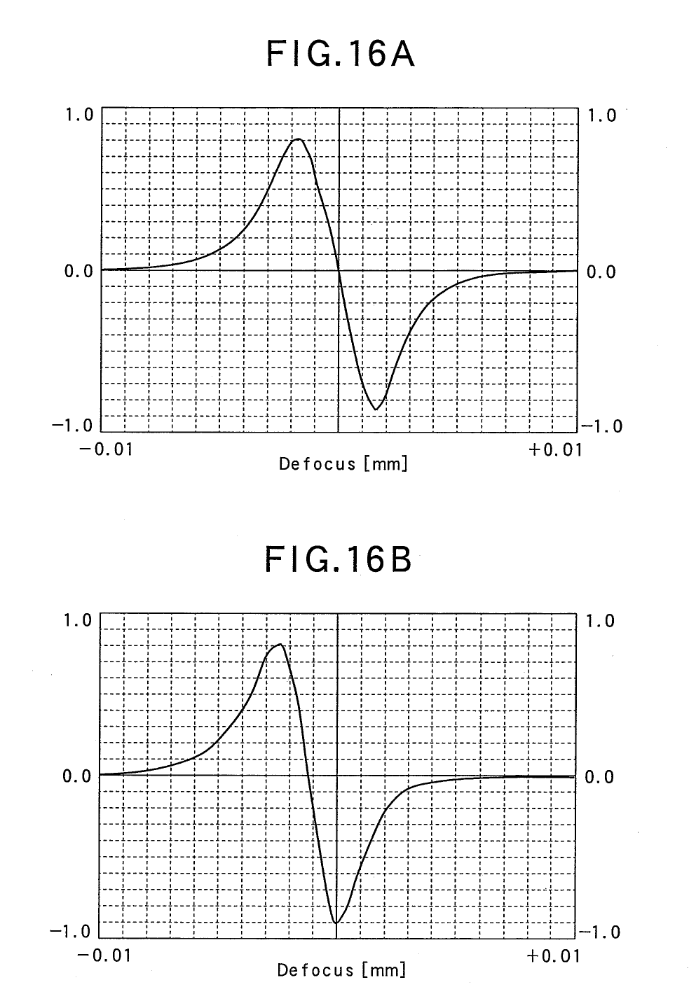

The focus error signal Sfes that is obtained when the construction described above is employed will be explained with reference to FIG. 16. In FIG. 16, (a) is a graph showing the characteristics of the focus error signal Sfes that is obtain by the astigmatic method when the sub beam to which an astigmatism has been given is shone onto the optical disc DK, and (b) is a graph showing the characteristics of a focus error signal when a defocused sub beam is shone onto the optical disc DK. Also, in FIG. 16, the horizontal axis indicates the amount of defocus, and the vertical axis indicates the signal level of the focus error signal.

As shown in FIG. 16, it can be seen that when the defocused sub beam is shone onto the optical disc DK, the focus error signal shifts in the direction of the horizontal axis. With this kind of characteristic, it is difficult to set a target value when performing the focus servo, so focus compensation cannot be performed properly. On the other hand, when using a sub beam to which an astigmatism has been given as in this variation, the curve that indicates the focus error signal does not shift, and the value of the focus error signal Sfes when the amount of defocus is ‘0’ also becomes ‘0’. Therefore, the focus servo should be performed so that that value of the focus error signal Sfes becomes ‘0’, and it becomes possible to perform focus compensation properly.

In this way, with this variation, based on the received optical signals from the sub optical receiving section 192, it becomes possible to obtain a focus error signal Sfes over which the track information component does not overlap, and thus it is possible to prevent a drop in focus compensation accuracy due to track cross noise that occurs when crossing tracks.

### (3) Variation 3

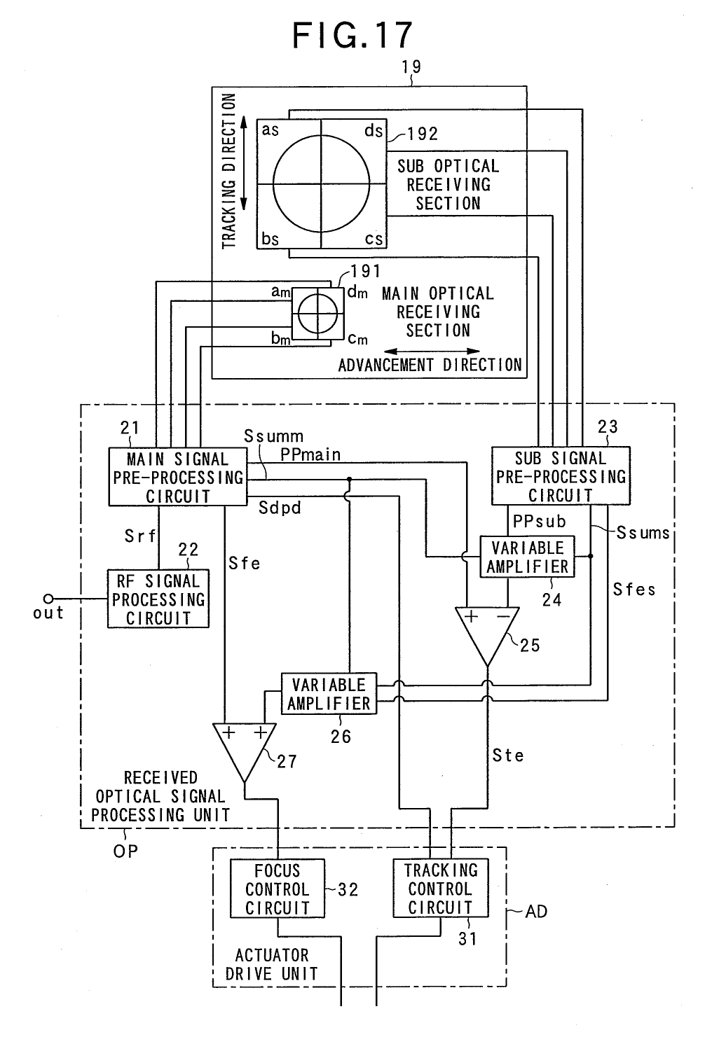

Next, a third variation of the embodiment described above will be explained with reference to FIG. 17. FIG. 17 is a block diagram showing the detailed construction of the OEIC 19, received optical signal processing unit OP and actuator drive unit AD of this variation.

In the embodiment described above, construction is used in which focus compensation is performed based on a focus error signal Sfe that is output from the main signal pre-processing circuit 21, however, it is possible to perform focus error compensation based on the sum of the focus error signal Sfe and focus error signal Sfes that corresponds to the sub reflected light. In this case, the sub signal pre-processing circuit 23 generates a focus error signal Sfes by the same method as in variation 2, and outputs that generated focus error signal Sfes to a variable amplifier 26.

Also, sample signals Ssumm and Ssums are supplied to this variable amplifier 26 from the main signal pre-processing circuit 21 and sub signal pre-processing circuit 23, respectively. The variable amplifier 26 amplifies the focus error signal Sfes according to the ratio between sample signals Ssumm and Ssums, and supplies a focus error signal Sfes for which the diffraction efficiency portion of the main beam and sub beam has been compensated for to an adder 27.

Moreover, the adder 27 adds the focus error signal Sfe that was supplied from the main signal pre-processing circuit 21 with the focus error signal Sfes that was supplied from the sub signal pre-processing circuit 23, and outputs the result to the focus control circuit 32. As a result, the focus control circuit 32 executes focus control, making is possible to realize an adequate focus servo.

### (4) Variation 4

In the embodiment described above, the case of using one sub beam was explained, however, it is possible to use two sub beams, a and b. In that case, two push-pull signals PPsuba and PPsubb are generated based on the received optical signals that respectively correspond to sub beam a and sub beam b, and after the push-pull signals PPsuba and PPsubb are added, by subtracting the result from the push-pull signal PPmain, it is possible to obtain a tracking error signal Ste having a better S/N ratio. Also, similarly, in regards to the focus error signal, it is possible to generate two focus error signals Sfesa and Sfesb based on received optical signals that respectively correspond to sub beams a and b, and by adding those focus error signals Sfesa and Sfesb, it is possible to obtain a focus error signal having a good S/N ratio.

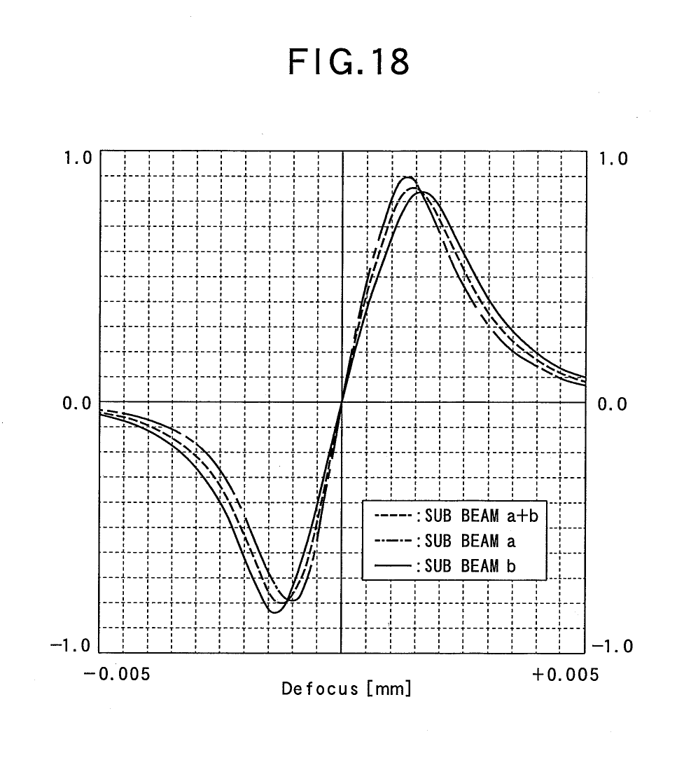

In this case, as shown in FIG. 10 described above, the size of the spot that corresponds to sub beam a at the sub optical receiving section 192 of the OEIC 19 is large, and the size of the spot that corresponds to sub beam b is small. Therefore, as shown in FIG. 18, the capture range is a little different for the focus error signal Sfesa of sub beam a and the focus error signal Sfesb of sub beam b. However, the zero cross matches so by adding both focus error signals Sfesa and Sfesb, it is possible to obtain a focus error signal having a good S/N ratio. Furthermore, the first focal line of sub beam a and the second focal line of sub beam b are such that they cross each other orthogonally. Therefore, the light distributions of the sub reflected light a and b on the sub optical receiving section 192 of the OEIC 19 are inverted from each other. Here, the sub beams a and b, and the push-pull signals PPsuba and PPsubb are given by the following equations.

PPsuba=(asa+dsa)−(bsa+csa) Equation 20

PPsubb=(asb+dsb)−(bsb+csb) Equation 21

PPsub=PPsuba+PPsubb Equation 22

(Here, asa, bsa, csa and dsa are received optical signals that correspond to each of the divided regions of the sub optical receiving section that corresponds to sub beam a, and asb, bsb, csb and dsb are received optical signals that correspond to each of the divided regions of the sub optical receiving section that corresponds to sub beam b.) The sub beams are compared with a certain time, and a push-pull signal PPsub that does not depend on the angle between the track and focal line is obtained.

In this way, with this variation, by using sub beams a and b, it is possible to improve the reliability of the push-pull signal PPsub. Also, movement over the sub beam detector due to changes in wavelength are complimentary to each other, so a highly reliable pickup can be obtained.

### (5) Variation 5

In the embodiment described above, information is recorded onto or reproduced from an optical disc DK having BD format, and an example of the case in which the technical concept of the present invention is applied to a so-called 1 beam 1 disc type information recording/reproduction device RP is explained. However, the recording format of the optical disc DK is arbitrary, for example, the present invention can be realized using similar construction as in the embodiment described above for the case of recording data onto or reproducing data from an optical disc DK having another kind of recording format, such as a CD (Compact Disc), DVD, HD-DVD (High Definition-DVD) or the like.

Moreover, the number of recording formats for which recording and reproduction can be performed by the information recording/reproduction device RP is arbitrary, for example, a similar effect can be obtained by giving an astigmatism to a sub beam by a similar method even in the case of an optical pickup device PU that corresponds to the four recording formats CD, DVD, BD ad HD-DVD. Also, the number of object lenses 171 in this case is arbitrary, and it is possible to use one compatible object lens 171, or to use a plurality of object lenses 171.

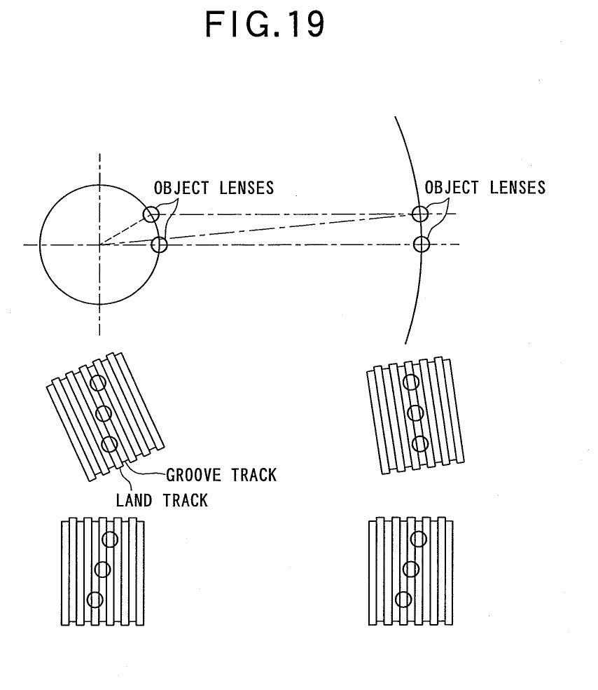

Here, in the case where a plurality of object lenses 171 is used in the optical pickup device PU, as shown in FIG. 19, due to the restrictions during manufacturing, even though one of the object lenses can be placed on the slider axis of the optical pickup device (or in other words, the axis that corresponds to the radial axis of the optical disc), there is a possibility that the other object lenses must be placed in a position that is shifted in the tangential direction (or in other words, direction of track advancement). When an object lens is placed at a position that has shifted from the slider direction in this way, then as shown in FIG. 19, the angle of the track contact line changes linearly from the inner section of the optical disk toward the outer section at the position of the object lens. When this happens, as the search position on the optical disc changes, a phenomenon occurs in which the sub beam moves in the direction of a line normal to the track, and the position where the sub beam is shone onto the track changes.

Even when this happens, by using construction in which and astigmatism is given to the sub beam as in the case of the information recording/reproduction device RP of the embodiment described above, there is a large advantage in that accurate tracking compensation can be performed without receiving the effects due to change of the position where the sub beam is shone onto the optical disc.

The present invention is not limited to the embodiment described above. The embodiment described above is just an example, and any construction that is essentially the same as the technical scope as disclosed in the claims of the invention, and that displays the same effect is within the technical range of the present invention.

Moreover, Japanese patent application No. 2005-184135, including the description, claims, drawings and abstract thereof, filed on Jun. 23, 2005 is included in its entirety as a reference.

1. An optical pickup device comprising:
a diffraction device for diffracting a light beam that is projected from a light source and projecting a main beam and a sub beam;
a focusing device for focusing the main beam and the sub beam onto an optical recording medium having a recording track; and
an optical receiving device for receiving light of the main beam and the sub beam that is reflected by the optical recording medium, and outputting a received optical signal corresponding to each beam; wherein
the diffraction device gives an astigmatism to just the sub beam;
the focusing device focuses the sub beam onto the optical recording medium between (a) a first focal line and (b) a second focal line that orthogonally crosses the first focal line of the sub beam to which the astigmatism has been given; and
the diffraction device sets the angle that is formed between the axis that is parallel to the recording track and the first focal line when giving the astigmatism so that it is within the range of 45°±12°.

2. The optical pickup device of claim 1, wherein
the focusing device focuses the sub beam onto the optical recording medium between the first focal line and the second focal line near a position where the sub beam becomes the circle of least confusion.

3. The optical pickup device of claim 1, wherein
the focusing device comprises at least:
an object lens that focuses the main beam and the sub beam onto the optical recording medium; and
a movement mechanism that changes the position of the object lens with respect to the optical recording medium.

4. The optical pickup device of claim 3, further comprising: a push-pull signal generation device for generating a main push-pull signal that corresponds to the main beam, and a sub push-pull signal that corresponds to the sub beam based on received optical signals that are output from the optical receiving device;
a difference signal generation device for generating a difference signal of the difference between the generated main push-pull signal and the sub push-pull signal; and
a tracking control device for controlling the movement mechanism based on the generated difference signal, and performing tracking compensation.

5. The optical pickup device of claim 4, wherein
the optical receiving device receives the reflected light that corresponds to the sub beam according to four divided regions that are divided by a division line that corresponds to an axis that is parallel to the recording track, and a division line that corresponds to an axis that orthogonally crosses the recording track, and outputs the received optical signals for each region; and
the push-pull signal generation device generates the sub push-pull signal based on the received optical signals that are output for each the region.

6. The optical pickup device of claim 5 further comprising:
an astigmatism device for further giving an astigmatism to the reflected light that corresponds to the sub beam;
a focus error signal generation device for generating a focus error signal based on the received optical signals that are output for each of the four divided regions by the optical receiving device; and
a focus control device for controlling the focus by controlling the movement mechanism based on the generated focus error signal.

7. The optical pickup device of claim 4, wherein
when two sub beams, a first sub beam and second sub beam, are projected from the diffraction device,
the push-pull signal generation device generates sub push-pull signals to correspond to the first and second sub beams; and
the difference signal generation device adds the sub push-pull signals that correspond to the first and second sub beams, and generates a difference signal of the difference between the added sub push-pull signals and the main push-pull signal.

8. The optical pickup device of claim 3 further comprising:
an astigmatism device for further giving an astigmatism to the reflected light that corresponds to the main beam and the sub beam; and
a focus control device for controlling the focus by controlling the movement mechanism based on the reflected light to which the astigmatism has been given.

9. The optical pickup device of claim 8, wherein the focus control device controls the movement mechanism based on a received optical signal that corresponds to the reflected light of the main beam.

10. The optical pickup device of claim 8, wherein the focus control device controls the movement mechanism based on a received optical signal that corresponds to the reflected light of the sub beam.

11. The optical pickup device of claim 10, wherein
when two sub beams, a first sub beam and second sub beam, are projected from the diffraction device,
the focus control device generates two focus error signals based on received optical signals that correspond to the first and second sub beams, and controls the movement mechanism based on the two generated focus error signals.

12. (canceled)
